(19) United States
(12) Patent Application Publication
(10) Pub. No.: US 2026/0296832 A1
(43) Pub. Date: Oct. 1, 2026

(54) Elevator Input System and Method of Controlling the Same

(71) Applicant: HYUNDAI ELEVATOR CO., LTD, Chungcheongbuk-do (KR)

(72) Inventors: Min Yeong Kim, Chungcheongbuk-do (KR); Yeon Ho Sung, Chungcheongbuk-do (KR)

(21) Appl. No.: 18/705,025

(22) PCT Filed: Nov. 3, 2023
(86) PCT No.: PCT/KR2023/017560

§ 371 Date: Apr. 26, 2024

(30) Foreign Application Priority Data
Nov. 2, 2023 (KR) 10-2023-0149949

(51) Int. Cl. B66B 1/46

(52) U.S. Cl. CPC B66B 1/468; B66B 2201/4615; B66B 2201/4646

(57) ABSTRACT

An elevator input system is disclosed. The elevator input system includes: a call module including a contactless input unit and receiving a call signal for calling an elevator car to a corresponding floor through the contactless input unit. The elevator input system also includes a voice output unit requesting a passenger to provide destination floor-related voice information, and a destination floor input module including a voice analyzer confirming destination floor information based on the destination floor-related voice information provided by the passenger. The elevator input system also includes a display unit displaying the destination floor information, and a controller calling the elevator car in response to the call signal and controlling operation of the voice output unit, the destination floor input module, and the display unit.

### CROSS REFERENCE TO RELATED APPLICATIONS

The present application is a § 371 national stage of international application no. PCT/KR 2023/017560, filed on Nov. 3, 2023, which claims priority to Korean application no. 10-2023-0149949, filed on Nov. 2, 2023, the contents of both disclosures being hereby incorporated by reference herein.

### FIELD

The present invention relates to an elevator input system and a method of controlling the same.

### BACKGROUND

In various high-rise buildings for residential and business purposes, elevators are installed to facilitate vertical movement of passengers visiting such buildings.

To use an elevator, a passenger calls an elevator car by pressing an up or down call button on the elevator with their hand, boards the elevator car, and presses a button corresponding to their destination floor.

However, when the passenger is carrying baggage in both hands or is carrying a bulky object, the passenger has to put down the baggage prior to pressing the button or has to use a corner of the baggage to press the button due to difficulty in using their hands. Further, if the passenger makes an excessive body motion, such as pressing a destination floor input button using other body parts than hands or the corner of the baggage, this can cause damage to the button or safety problems.

Call buttons provided to an elevator hall to call an elevator car often include a foot button configured to allow a passenger to input a call using their foot in addition to a push button operated by hand.

However, since such a conventional foot button only provides the function of calling an elevator car, a passenger still has to suffer the inconvenience of putting down their baggage and pressing a destination floor input button to register a destination floor after boarding the elevator car.

Although technologies capable of calling an elevator car or inputting a destination floor using voice recognition are being developed, these technologies have difficulty in efficiently implementing control for elevator car calling and destination floor input and a sequential process therefor.

In addition, when multiple passengers input their respective destination floors using voice recognition, it is not possible to check already input destination floors, causing duplicate input of destination floors and inability to efficiently implement input of an additional destination floor.

### SUMMARY

It is one aspect of the present invention to provide an elevator input system that can efficiently implement and control a call for an elevator car and input of a destination floor by activating a voice recognition function while calling the elevator car in a contactless manner, and a method of controlling the same.

It is another aspect of the present invention to provide an elevator input system that allows multiple passengers to confirm their destination floors by providing elevator-car calling information and destination floor information through a display device and allows additional destination floors to be input by voice, and a method of controlling the same.

In accordance with one aspect of the present invention, an elevator input system includes: a call module including a contactless input unit and receiving a call signal for calling an elevator car to a corresponding floor through the contactless input unit; a voice output unit requesting a passenger to provide destination floor-related voice information; a destination floor input module including a voice analyzer confirming destination floor information based on the destination floor-related voice information provided by the passenger; a display unit displaying the destination floor information; and a controller calling the elevator car in response to the call signal and controlling operation of the voice output unit, the destination floor input module, and the display unit.

The contactless input unit may include at least one of a foot button-based call unit, a detection area recognition-based call unit, or a camera image analysis-based call unit, wherein the foot button-based call unit may include a contactless sensor and allowing the passenger to input the call signal to the contactless sensor using a part of the body including a foot or using an object, the detection area recognition-based call unit may include an object detection sensor and may allow the call signal to be input based on the presence of the passenger in a detection area in a corresponding elevator hall, and the camera image analysis-based call unit may include a camera and an image analyzer, wherein the camera may photograph the elevator hall and the image analyzer may analyze an image acquired by the camera to determine the presence of the passenger in the elevator hall and may allow the call signal to be input based on analysis results.

The detection area recognition-based call unit and the camera image analysis-based call unit may determine the presence of an additional passenger in real time, the voice output unit may further request the additional passenger to provide additional destination floor-related voice information, the voice analyzer of the destination floor input module may confirm additional destination floor information, and the display unit may display the additional destination floor information.

The voice output module may include a speaker and may request the passenger to provide the destination floor-related voice information through the speaker, the destination floor input module may further include a microphone and may receive the destination floor-related voice information from the passenger through the microphone, and the display unit may display call information for the elevator car.

In accordance with another aspect of the present invention, a method of controlling an elevator input system includes: a contactless call input step in which an elevator car is called through a contactless input unit; a contactless call recognition step in which a determination is made as to whether there is a call for the elevator car through the contactless input unit; a destination floor voice information request step in which a voice output unit requests a passenger to provide destination floor-related voice information when the call for the elevator car is confirmed in the contactless call recognition step; a destination floor voice information recognition step in which destination floor information is confirmed by analyzing the voice information provided by the passenger; and an elevator car calling and destination floor display step in which the elevator car is called to a corresponding floor based on the confirmed destination floor information and a display unit displays the destination floor information.

When the destination floor information is not confirmed in the destination floor voice information recognition step, the elevator car may be called to the corresponding floor and a destination floor may be input through destination floor input invocation and voice information input performed by the passenger aboard the elevator car, or the elevator car may be called to the corresponding floor in response to input through a call button and the destination floor may be input through destination floor input invocation and voice information input performed by the passenger aboard the elevator car.

In accordance with a further aspect of the present invention, a method of controlling an elevator input system includes: a contactless call input step in which an elevator car is called through a contactless input unit; a contactless call recognition step in which a determination is made as to whether there is a call for the elevator car through the contactless input unit; an elevator car calling step in which the elevator car is called to a corresponding floor when the call for the elevator car is confirmed in the contactless call recognition step; a destination floor voice information request step in which a voice output unit requests a passenger to provide destination floor-related voice information; a destination floor voice information recognition step in which destination floor information is confirmed by analyzing the voice information; and a destination floor display step in which a display unit displays the destination floor information.

When the destination floor information is not confirmed in the destination floor voice information recognition step, a destination floor may be input through destination floor input invocation and voice information input performed by the passenger aboard the elevator car.

The method may further include: an additional destination floor input invocation step in which a voice output unit is invoked to input an additional destination floor; an additional destination floor voice information request step in which the voice output unit requests additional destination floor-related voice information; an additional destination floor voice information recognition step in which a voice analyzer recognizes the additional destination floor-related voice information; and an additional destination floor display step in which additional destination floor information is displayed.

The method may further include: an additional passenger confirmation step in which an additional passenger is confirmed through the contactless input unit; an additional destination floor voice information request step in which the voice output unit requests additional destination floor-related voice information; an additional destination floor voice information recognition step in which a voice analyzer recognizes the additional destination floor-related voice information; and an additional destination floor display step in which additional destination floor information is displayed.

The method may further include: a destination floor correction invocation step in which a voice output unit is invoked to correct and input a destination floor; a corrected destination floor voice information request step in which the voice output unit requests the passenger to provide corrected destination floor-related voice information; a corrected destination floor voice information recognition step in which a voice analyzer recognizes the corrected destination floor-related voice information; and a corrected destination floor display step in which corrected destination floor information is displayed.

When the corrected destination floor information is not confirmed in the corrected destination floor voice information recognition step, the corrected destination floor voice information request step may be performed.

According to the present invention, it is possible to call an elevator car in a contactless manner and to input a destination floor by voice, thereby allowing a passenger to conveniently board the elevator car and move to the destination floor even in situations where it is difficult to use their hands, while preventing damage to property and safety incidents.

In addition, it is possible to check elevator car calling information and destination floor information in real time, thereby preventing crosstalk even when multiple passengers use an elevator, while ensuring efficient control and operation of the elevator.

### BRIEF DESCRIPTION OF THE DRAWINGS

FIG. 1 is a schematic diagram of an elevator input system according to one embodiment of the present invention.

FIG. 2 is an in-use view schematically illustrating an elevator hall employing an elevator input system according to one embodiment of the present invention.

FIG. 3 is a first schematic view of an input/output unit in an elevator hall including the elevator input system of FIG. 2, according to another embodiment.

FIG. 4 is a second schematic view of the input/output unit according to another embodiment.

FIG. 5 is a first schematic view of an input/output unit in the elevator hall including the elevator input system of FIG. 2, according to a further embodiment.

FIG. 6 is a second schematic view of the input/output unit according to a further embodiment.

FIG. 7 is a schematic flowchart illustrating an elevator input system control method according to a first embodiment of the present invention.

FIG. 8 is a schematic flowchart illustrating an elevator input system control method according to a second embodiment of the present invention.

FIG. 9 is a schematic flowchart illustrating an elevator input system control method according to a third embodiment of the present invention.

FIG. 10 is a schematic flowchart illustrating an elevator input system control method according to a fourth embodiment of the present invention.

FIG. 11 is a schematic flowchart illustrating an elevator input system control method according to a fifth embodiment of the present invention.

### DETAILED DESCRIPTION

Hereinafter, embodiments of the present invention will be described in detail with reference to the accompanying drawings such that the present invention can be easily implemented by those skilled in the art. It should be understood that the present invention may be embodied in different ways and is not limited to the following embodiments.

In the drawings, portions irrelevant to the description will be omitted for clarity. Like components will be denoted by like reference numerals throughout the specification.

As used herein, the terms “includes”, “comprises”, “including” and/or “comprising” specify the presence of stated features, steps, operations, elements, and/or components, but do not preclude the presence or addition of one or more other features, steps, operations, elements, components, and/or groups.

It will be understood that the invention described in this disclosure is not intended to be limited to any particular embodiment, and includes various modifications, equivalents, and/or alternatives to the embodiments of this disclosure.

As used herein, the expression “configured to” may be used interchangeably with, for example, “suitable for”, “having the capacity to”, “designed to”, “adapted to”, “made to”, or “capable of” depending on the context. The expression “configured (or set up) to” may not necessarily mean “specifically designed (hardware wise) to”. Instead, in a certain context, the expression “a device configured to” may mean that the device is “capable of” doing something in conjunction with other devices or components.

It will be understood that the related literature described in this disclosure is incorporated herein by reference in its entirety and that a person having ordinary skill in the art will be able to apply what is described in the related literature to the matter briefly described herein.

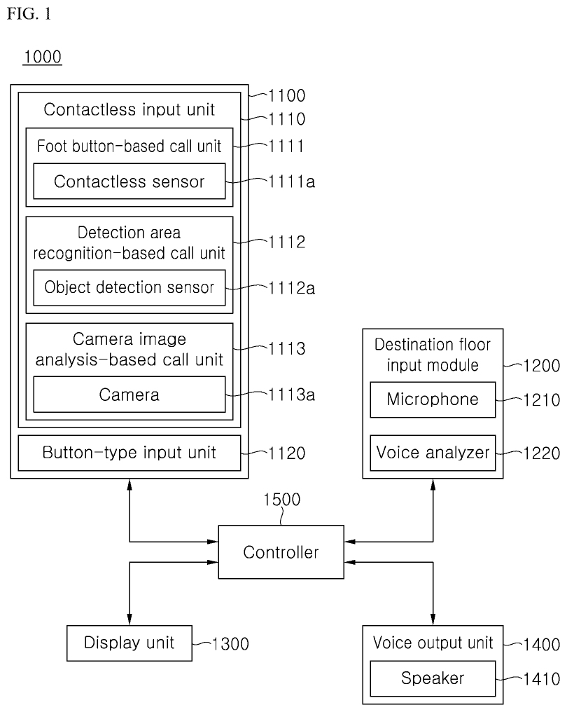

FIG. 1 is a schematic diagram of an elevator input system according to one embodiment of the present invention.

Referring to FIG. 1, the elevator input system 1000 according to this embodiment includes a call module 1100, a destination floor input module 1200, a display unit 1300, a voice output unit 1400, and a controller 1500.

More specifically, the call module 1100 serves to call an elevator car to a corresponding floor. The call module 1100 includes a contactless input unit 1110 and a button-type input unit 1120.

The contactless input unit 1110 recognizes a call from a passenger in a contactless manner and may include a foot button-based call unit 1111, a detection area recognition-based call unit 1112, and a camera image analysis-based call unit 1113.

The foot button-based call unit 1111 recognizes a call signal through detection of a passenger foot. Here, the passenger may also input a call signal using an object or other body parts than the foot.

The foot button-based call unit 1111 includes a contactless sensor 1111a and confirms a call signal based on signal detection by the contactless sensor 1111.

The contactless sensor 1111a includes a photoelectric sensor and monitors the presence of an object by directing a sensor beam toward a floor of an elevator hall. The contactless sensor 1111a may be a direct reflection photoelectric sensor.

The foot button-based call unit 1111 may further include an illumination part and an acoustic part to be implemented more efficiently.

The illumination part serves to provide a visual guide to indicate a point to which a sensor beam from the contactless sensor 1111a is directed, and illuminates a specific area on the floor of the elevator hall.

The acoustic part provides a sound, such as a buzzer sound, to inform a passenger of whether the contactless sensor 1111a recognizes a call signal. That is, the passenger can confirm input of the call signal by the sound output from the acoustic part.

The detection area recognition-based call unit 1112 detects the presence of a passenger in a detection area in an elevator hall and allows a call signal to be input based detection results.

The detection area recognition-based call unit 1112 includes an object detection sensor 1112a to detect an object in the detection area. For example, the object detection sensor 1112a may be a millimeter-wave radar sensor for precise analysis.

The object detection sensor 1112a may determine the presence of a passenger using additional information, such as information as to whether an object having stopped moving in the direction of travel or an object whose moving speed is slowing down considerably is present in the detection area.

That is, even when there is an object in the detection area at a specific time, a controller does not determine the object as a passenger if the object is moving in one direction without slowing pace.

The camera image analysis-based call unit 1113 includes a camera 1113a and an image analyzer (not shown), determines the presence of a passenger in the elevator hall, and allows a call signal to be input based on determination results.

The camera 1113a photographs the elevator hall, and the image analyzer analyzes an image acquired by the camera 1113a to determine the presence of a passenger in the elevator hall. The camera 1113a may be a security camera.

As compared with the foot button-based call unit 1111, the detection area recognition-based call unit 1112 and the camera image analysis-based call unit 1113 provides real-time determination of the presence or absence of an additional passenger and may be configured to allow real-time confirmation of an additional passenger and input of an additional destination floor as described below.

Additionally, the elevator input system according to this embodiment may allow a passenger to call an elevator car using a conventional button-type input unit 1120 without using the contactless input unit.

The button-type input unit 1120 includes an elevator call button, and a passenger may select either the contactless input unit 1110 or the button-type input unit 1120 to call an elevator car.

When an elevator car calling signal is input through the call module 1100 according to this embodiment, the controller 1500 requests the passenger to provide destination floor-related voice information through the voice output unit 1400.

That is, the call module 1100 performs a function of activating the voice output unit along with a function of calling an elevator car.

The voice output unit 1400 includes a speaker 1410. The voice output unit 1400 requests the passenger to provide destination floor-related voice information through the speaker 1410. By way of example, the voice output module 1400 may output a voice message such as “Please tell me your destination floor” or “What floor are you going to?”.

The destination floor input module 1200 includes a microphone 1210 and a voice analyzer 1220 and receives the destination floor-related voice information from the passenger.

When the passenger provides the destination floor-related voice information according to instructions of the voice output module 1400, the microphone 1210 receives the voice information and the voice analyzer 1220 analyzes the voice information provided by the passenger to extract destination floor information.

The destination floor input module 1200 transmits the extracted destination floor information to the controller 1500, which, in turn, provides the destination floor information to the display unit 1300.

The destination floor input module 1200 may further include: an additional destination floor input invocation function that is invoked by an additional passenger to input an additional destination floor; and a destination floor correction invocation function that is invoked to correct a destination floor.

In response to additional destination floor input invocation or destination floor correction invocation, the voice analyzer 1220 analyzes a passenger voice and transmits information corresponding thereto to the controller 1500, which, in turn, transmits the information to the voice output unit 1400.

The display unit 1300 serves to provide the passenger with elevator car call information and destination floor information. When a plurality of passengers inputs respective destination floor information, the display unit 1300 displays a plurality of destination floors.

When an elevator car-calling signal is input through the call module 1100 before the display unit 1300 displays a destination floor, the controller 1500 provides a call result to the display unit 1300, which, in turn, displays the call result first.

Then, upon receiving destination floor information from the destination floor input module 1200, the controller 1500 provides the destination floor information to the display unit 1300, which, in turn, displays the destination floor information.

The controller 1500 calls an elevator car based on call information acquired through the call module 1100 and controls operation of the voice output unit 1400, the destination floor input module 1200, and the display unit 1300.

In addition, the controller 1500 may set the volume of the speaker 1410 of the voice output unit 1400 according to time of day to prevent noise-related problems.

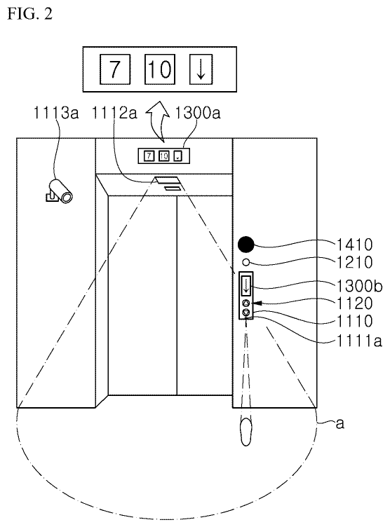

FIG. 2 is an in-use view schematically illustrating an elevator hall employing the elevator input system according to one embodiment of the present invention.

Referring to FIG. 2, the elevator hall may be provided with: a button-type input unit 1120; a microphone 1210; a speaker 1410; display units 1300a, 1300b; and at least one selected from among a foot button-based call unit 1111 including a contactless sensor 1111a (see FIG. 1), a detection area recognition-based call unit 1112 including an object detection sensor 1112b (see FIG. 1), and an image analysis-based call unit 1113 including a camera 1113a (see FIG. 1).

The contactless sensor 1111a may be mounted on a contactless input unit 1110, and additional components for implementing the foot button-based call unit 1111, that is, an illumination part (not shown) and an acoustic part (not shown), may be mounted on the button-type input unit 1120.

Alternatively, the acoustic part may be implemented by the speaker 1410 of a voice output unit.

The camera 1113a is mounted near an elevator door and photographs the elevator hall to detect the presence of a passenger waiting in the elevator hall.

The object detection sensor 1112 may be disposed on an upper frame of the elevator door to detect the presence of a passenger in a specific area A in the elevator hall.

In addition, the contactless input unit 1110 may be equipped with the speaker 1410, the microphone 1210, the display unit 1300b, and the button-type input unit 1120.

The microphone 1210 and the speaker 1410 may be disposed adjacent to the button-type input unit 1120.

The display units 1300a, 1300b may include: a first display 1300a disposed on the upper frame of the elevator door; and a second display 1300b mounted on the button-type input unit 1120.

The second display 1300b may also be equipped with the speaker 1410 and the microphone 1210.

Elevator car call information and destination floor information may be displayed on either the first display 1300a or the second display 1300b. FIG. 2 shows an embodiment in which elevator car call information and destination floor information are displayed on the first display 1300a.

In FIG. 2, the first display 1300a indicates that an elevator car is descending in response to a call and destination floors are the 7th and 10th floors.

Additionally, the second display 1300b may also display destination floors.

The elevator hall employing the elevator input system according to this embodiment allows a passenger to call an elevator car through the contactless sensor 1111 and to input destination floor-related voice information through the microphone 1210.

Additionally, the camera 1113 may be installed inside the elevator car, and the object detection sensor 1112 may be disposed inside the first display 1300a.

Additionally, the camera 1113 or the object detection sensor 1112 may determine the presence of an additional passenger in real time. When there is an additional passenger in the elevator hall, the voice output unit may request the additional passenger to provide additional destination floor-related voice information through the speaker 1410.

When the additional passenger provides the additional destination floor-related voice information, the microphone 1210 may collect the voice information. A voice analyzer 1220 (see FIG. 1) may extract additional destination floor information from the voice information. The first display 1300a or the second display 1300b may display the additional destination floor information.

When the object detection sensor 1112 and the camera 1113 are not installed, the additional passenger may confirm the destination floor through the first display 1300a or the second display 1300b. When the additional passenger confirms that their destination floor is not registered, the additional passenger may be requested to input additional destination floor-related voice information by allowing the contactless sensor 1111 to recognize a part of their body or an object.

Additionally, the additional passenger may invoke an additional destination floor input function by voice, and the passenger may invoke a destination floor correction function by voice.

This will be described in more detail in an elevator input system control method described below.

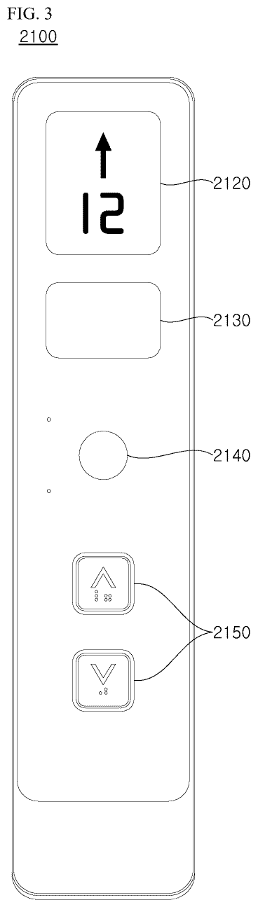

FIG. 3 is a first schematic view of an input/output unit in an elevator hall including the elevator input system of FIG. 2, according to another embodiment.

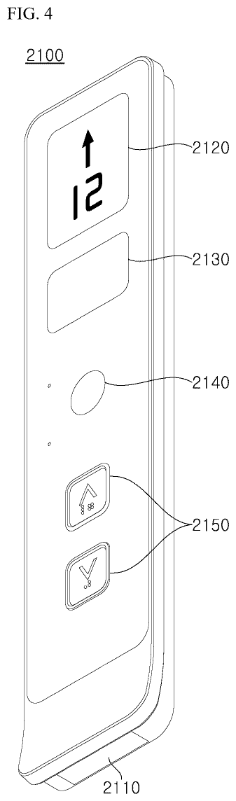

FIG. 4 is a second schematic view of the input/output unit according to another embodiment.

Referring to FIG. 3 and FIG. 4, the input/output unit 2100 according to this embodiment is mounted in an elevator hall and includes a contactless sensor 2110, a first display 2120, a second display 2130, a voice recognition unit 2140, and a button-type input unit 2150.

More specifically, the contactless sensor 2110 is configured to implement a foot button-based call unit and recognize a call signal by detecting a passenger foot. The contactless sensor 2110 is disposed at a lower end of the input/output unit 2100.

The first display 2120 displays information about the current floor and direction of travel of an elevator car.

The second display 2130 displays the current situation of an elevator (for example, “elevator is full”, “elevator is under maintenance”, and the like).

The voice recognition unit 2140 may indicate the state of recognition of a passenger voice information (for example, “voice recognition is ready”, “voice recognition is completed”, and the like) using a symbol or a shape. Additionally, the voice recognition unit 2140 may indicate the state of foot button-based passenger call.

The button-type input unit 2150 is configured to call an elevator car.

Additionally, the input/output unit 2100 according to this embodiment may further include an approach indication lamp (not shown). The approach indication lamp may be disposed at an upper end of the input/output unit 2100.

The approach indication lamp may inform a passenger of approach of an elevator car to a corresponding floor via flashing light.

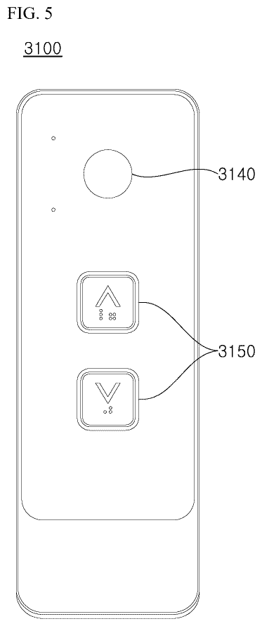

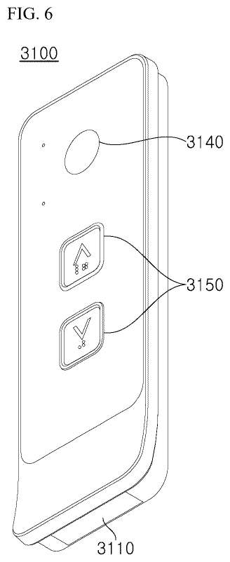

FIG. 5 is a first schematic view of an input/output unit in the elevator hall including the elevator input system of FIG. 2, according to a further embodiment. FIG. 6 is a second schematic view of the input/output unit according to a further embodiment.

Referring to FIG. 5 and FIG. 6, the input/output unit 3100 according to this embodiment is mounted in an elevator hall and includes a contactless sensor 3110, a voice recognition unit 3140, and a button-type input unit 3150.

Since the contactless sensor 3110, the voice recognition unit 3140, and the button-type input unit 3150 are the same as the contactless sensor 2110, the voice recognition unit 2140, and the button-type input unit 2150 shown in FIG. 3 and FIG. 4, detailed description thereof will be omitted.

The input/output unit 3100 may further include an approach indication lamp (not shown).

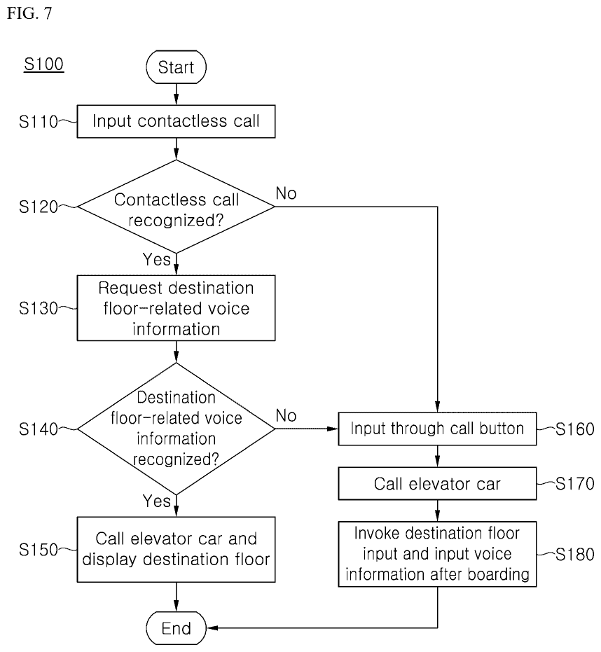

FIG. 7 is a schematic flowchart illustrating an elevator input system control method according to a first embodiment of the present invention.

Referring to FIG. 7, the elevator input system control method S100 according to this embodiment includes a contactless call input step S110, a contactless call recognition step S120, a destination floor voice information request step S130, a destination floor voice information recognition step S140, and an elevator car calling and destination floor display step S150.

More specifically, in the contactless call input step S110, an elevator car is called through the contactless input unit 1110.

By way of example, a passenger places a part of their body or an object in a recognition area of the contactless sensor 1111 to call the elevator car.

In the contactless call recognition step S120, a determination is made as to whether there is a call for the elevator car through the contactless input unit 1110.

When the call for the elevator car is recognized in the contactless call recognition step S120, a process proceeds to the destination floor voice information request step S130.

In the destination floor voice information request step S130, the voice output unit 1400 requests the passenger to provide destination floor-related voice information.

When the call for the elevator car is not recognized through the contactless input unit 1110 in the contactless call recognition step S120, the passenger may register a call for the elevator car in a call button input step S160. In an elevator car calling step S170, the controller 1500 may call the elevator car to a corresponding floor in a direction of travel marked on a call button.

In the destination floor voice information request step S130, the voice output unit requests the passenger to provide destination floor-related voice information through the speaker 1410.

When the passenger provides the destination floor-related voice information in response to the request for the destination floor-related voice information, the voice information is input through the microphone 1210 and the process proceeds to the destination floor voice information recognition step S140.

In the destination floor voice information recognition step S140, the voice analyzer 1220 analyzes the voice information provided by the passenger to confirm destination floor information.

When the destination floor information is recognized in the destination floor voice information recognition step S140, the process proceeds to the elevator car calling and destination floor display step S150.

In the elevator car calling and destination floor display step S150, the elevator car is called to a corresponding floor while the destination floor information is output through the display unit 1300.

Here, the controller 1500 calls the elevator car to the corresponding floor while transmitting the destination floor information to the display unit 1300.

In this way, the elevator input system control method S100 according to the first embodiment not only allows an elevator car to be called through a contactless call, but also allows a request for destination floor-related voice information to be activated.

When the destination floor information is not recognized in the destination floor voice information recognition step S140, the passenger may register a call for the elevator car in the call button input step S160. In the elevator car call step S170, the controller 1500 may call the elevator car in a direction of travel marked on a call button.

When the elevator car is called to the corresponding floor without the destination floor information being recognized, the passenger may input their destination floor after boarding the elevator car.

Here, the passenger aboard the elevator car may input the destination floor through a destination floor input invocation and voice information input step S180. To this end, the elevator car may be provided therein with the destination floor input module 1200 and the voice output unit 1400.

Here, destination floor input invocation is a process of calling the voice output unit 1400 to request the passenger to provide destination floor-related voice information through the voice output unit 1400.

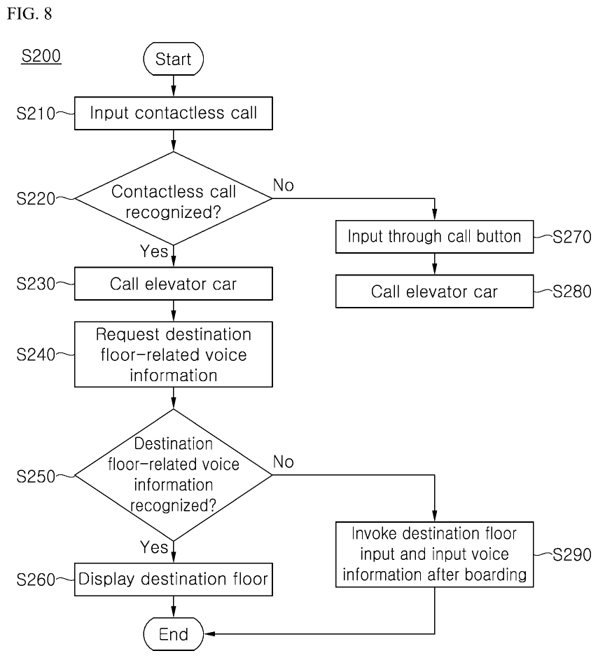

FIG. 8 is a schematic flowchart illustrating an elevator input system control method S200 according to a second embodiment of the present invention.

More specifically, the elevator input system control method S200 according to the second embodiment is substantially the same as the elevator input system control method S100 according to the first embodiment except that, so long as a contactless call is recognized, an elevator car is called to a corresponding floor regardless of whether destination floor-related voice information is recognized or not.

Referring to FIG. 8, the elevator input system control method S200 includes a contactless call input step S210, a contactless call recognition step S220, an elevator car calling step S230, a destination floor voice information request step S240, a destination floor voice information recognition step S250, and a destination floor display step S260.

In the contactless call input step S210, an elevator car is called through the contactless input unit 1110.

In the contactless call recognition step S220, a determination is made as to whether there is a call for an elevator car in a contactless manner.

When the call for the elevator car is recognized in the contactless call recognition step S220, the process proceeds to the elevator car calling step S220. In the elevator car calling step S230, the controller 1500 calls the elevator car to a corresponding floor.

When the call for the elevator car is not recognized in a contactless manner in the contactless call recognition step S220, the passenger may register a call for the elevator car in a call button input step S270. In an elevator car calling step S280, the controller 1500 may call the elevator car to a corresponding floor in a direction of travel marked on a call button.

After the controller 1500 calls the elevator car in the elevator car calling step S230, the process proceeds to the destination floor voice information request step S240.

In the destination floor voice information request step S240, the voice output unit 1400 requests the passenger to provide destination floor-related voice information.

That is, in the destination floor voice information request step S240, the passenger is requested for destination floor-related voice information through the speaker 1410.

When the passenger provides the destination floor-related voice information in response to the request for the destination floor-related voice information, the voice information may be input through the microphone 1210.

In the destination floor voice information recognition step 250, the voice analyzer 1220 analyzes the voice information provided by the passenger to confirm destination floor information.

When the destination floor-related voice information is recognized in the destination floor voice information recognition step 250, the process proceeds to the destination floor display step S260 and the controller 500 transmits the destination floor information to the display unit 1300.

In the destination floor display step S260, the destination floor information is output through the display unit 1300.

When the destination floor-related voice information is not recognized in the destination floor voice information recognition step S250, the elevator car may be called to a corresponding floor and the passenger may input their destination floor after boarding the elevator car. Alternatively, the passenger may call the elevator car to the corresponding floor and may input their destination floor after boarding the elevator car.

The passenger aboard the elevator car may input a destination floor through a destination floor input invocation and voice information input step S290. To this end, the elevator car may be provided therein with the destination floor input module 1200 and the voice output unit 1400.

Alternatively, when the destination floor-related voice information is not recognized in the destination floor voice information recognition step S250, the process may return to the destination floor voice information request step S240.

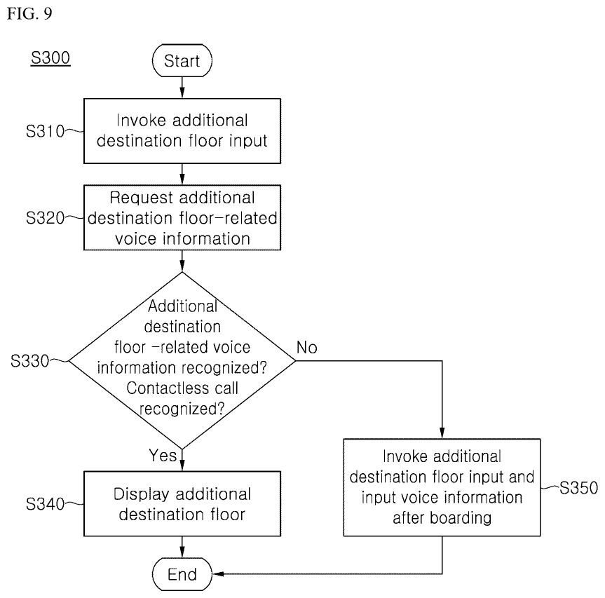

FIG. 9 is a schematic flowchart illustrating an elevator input system control method according to a third embodiment of the present invention.

The elevator input system control method S300 according to the third embodiment may further include additional steps for inputting a plurality of destination floors, as compared to the elevator input system control methods S100, S200 according to the first and second embodiments.

To this end, the elevator input system control method S300 according to the third embodiment further includes an additional destination floor input invocation step S310, an additional destination floor voice information request step S320, an additional destination floor voice information recognition step S330, and an additional destination floor display step S340.

In the additional destination floor input invocation step S310, the voice output unit 1400 is invoked by an additional passenger to input a destination floor.

For example, when the additional passenger arrives at an elevator hall after the elevator car calling and destination floor display step S150 in the first embodiment or after the destination floor display step S260 in the second embodiment, the additional passenger invokes the voice output unit 1400 to input a destination floor by voice.

By way of example, when the additional passenger provides voice information such as “additional destination floor”, the voice analyzer 1220 recognizes the voice information and the controller 1500 proceeds to the additional destination floor voice information request step S320.

In the additional destination floor voice information request step S320, the voice output unit 1400 requests the additional passenger to provide additional destination floor-related voice information.

Additionally, in the additional destination floor input invocation step S310, the passenger may send a call signal for inputting an additional destination floor using the foot button-based call unit of the contactless input unit.

When the additional destination floor-related voice information is recognized by the voice analyzer 1220 in the additional destination floor voice information recognition step S330, the process proceeds to the additional destination floor display step S340.

In the additional destination floor display step S340, additional destination floor information is output through the display unit 1300.

Here, the controller 1500 transmits the additional destination floor information to the display unit 1300, and the additional passenger may view the display unit 1300 to confirm the additional destination floor.

When the additional destination floor-related voice information is not recognized in the additional destination floor voice information recognition step S330, the additional passenger may input a destination floor after boarding the elevator car.

Here, the additional passenger aboard the elevator car may input the additional destination floor through an additional destination floor input invocation and voice information input step S350. To this end, the elevator car may be provided therein with the destination floor input module 1200 and the voice output unit 1400.

Alternatively, when the additional destination floor-related voice information is not recognized in the additional destination floor voice information recognition step S330, the process may return to the additional destination floor voice information request step S320.

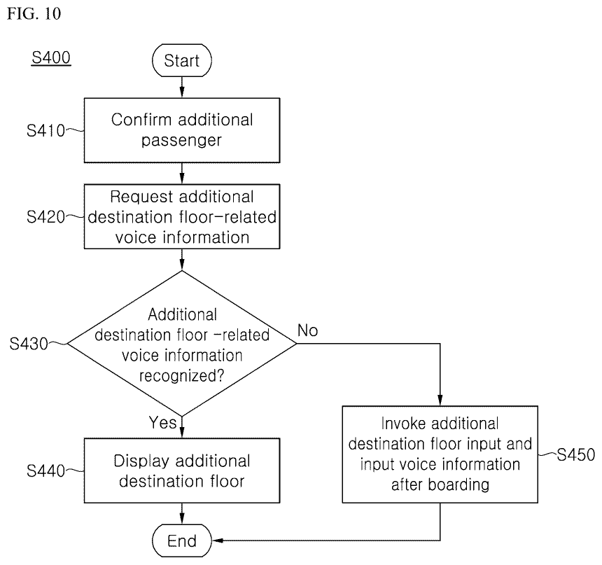

FIG. 10 is a schematic flowchart illustrating an elevator input system control method S400 according to a fourth embodiment of the present invention.

The elevator input system control method S400 according to the fourth embodiment differs from the elevator input system control method S300 according to the third embodiment in terms of how to confirm an additional passenger.

More specifically, in the elevator input system control method S300 according to the third embodiment, an additional passenger invokes the voice output unit to input an additional destination floor, whereas, in the elevator input system control method S400 according to the fourth embodiment, the contactless input unit determines the presence of an additional passenger in real time.

To this end, the elevator input system control method S400 according to the fourth embodiment further includes an additional passenger confirmation step S410, an additional destination floor voice information request step S420, an additional destination floor voice information recognition step S430, and an additional destination floor display step S440, as compared to the elevator input system control methods S100, S200 according to the first and second embodiments.

More specifically, in the additional passenger confirmation step S410, the presence of an additional passenger is determined in real time through the detection area recognition-based call unit and the camera image analysis-based call unit of the contactless input unit 1110.

When the presence of an additional passenger is confirmed in the additional passenger confirmation step S410, the process proceeds to the additional destination floor voice information request step S420.

In the additional destination floor voice information request step S420, the voice output unit 1400 requests the additional passenger to provide additional destination floor-related voice information.

When the additional destination floor-related voice information is recognized by the voice analyzer 1220 in the additional destination floor voice information recognition step S430, the process proceeds to the additional destination floor display step S440.

In the additional destination floor display step S440, additional destination floor information is output through the display unit 1300.

Here, the controller 1500 transmits the additional destination floor information to the display unit 1300, and the additional passenger may view the display unit 1300 to confirm the additional destination floor.

When the additional destination floor-related voice information is not recognized in the additional destination floor voice information recognition step S430, the additional passenger inputs a destination floor after boarding the elevator car.

Here, the additional passenger aboard the elevator car may input the additional destination floor through an additional destination floor input invocation and voice information input step S470. To this end, the elevator car may be provided therein with the destination floor input module 1200 and the voice output unit 1400.

Alternatively, when the additional destination floor-related voice information is not recognized in the additional destination floor voice information recognition step S430, the process may return to the additional destination floor voice information request step S420.

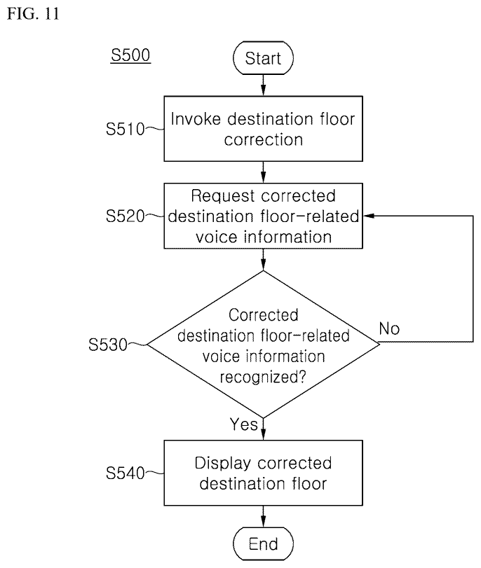

FIG. 11 is a schematic flowchart illustrating an elevator input system control method according to a fifth embodiment of the present invention.

The elevator input system control method S500 according to the fifth embodiment may further include additional steps for correcting and inputting a destination floor, as compared to the elevator input system control methods S100, S200 according to the first and second embodiments.

To this end, the elevator input system control method S500 according to the fifth embodiment further includes a destination floor correction invocation step S510, a corrected destination floor voice information request step S520, a corrected destination floor voice information recognition step S530, and a corrected destination floor display step S540, as compared to the elevator input system control methods S100, S200 according to the first and second embodiments.

More specifically, in the destination floor correction invocation step S510, a passenger invokes the voice output unit 1400 to correct a destination floor.

For example, when incorrect destination floor-related information is displayed in the elevator car calling and destination floor display step S150 of the first embodiment or in the destination floor display step S260 of the second embodiment, the passenger invokes the voice output unit 1400 to correct the destination floor.

By way of example, when an additional passenger provides voice information such as “correct destination floor”, the voice analyzer 1220 recognizes the voice information and the controller 1500 proceeds to the corrected destination floor voice information request step S520.

In the corrected destination floor voice information request step S520, the voice output unit 1400 requests the passenger to provide corrected destination floor-related voice information.

When the corrected destination floor-related voice information is recognized in the corrected destination floor voice information recognition step S530, the process proceeds to the corrected destination floor display step S540.

In the corrected destination floor display step S540, corrected destination floor information is output through the display unit 1300.

Here, the controller 1500 transmits the corrected destination floor information to the display unit 1300, and the passenger may view the display unit 1300 to ascertain whether the destination floor has been corrected.

When the corrected destination floor-related voice information is not recognized in the corrected destination floor voice information recognition step S530, the process returns to the corrected destination floor voice information request step S520.

While the preferred embodiments of the present invention have been described with reference to the drawings as above, it should be understood that the foregoing embodiments are provided for illustration only and are not to be in any way construed as limiting the present invention, and that various modifications, changes, alterations, and equivalent embodiments can be made by those skilled in the art without departing from the spirit and scope of the disclosure. For example, even when the invention described herein is performed in a different order than described herein and/or the components of the described systems, structures, devices, circuits, etc. are combined or assembled in a different form than described herein or are substituted or replaced by other components or equivalents thereto, suitable results can be achieved.

Therefore, other implementations, other embodiments, and equivalents to the appended claims fall within the scope of the claims.

1. An elevator input system comprising:
a call module comprising a contactless input unit and receiving a call signal for calling an elevator car to a corresponding floor through the contactless input unit;
a voice output unit requesting a passenger to provide destination floor-related voice information;
a destination floor input module comprising a voice analyzer confirming destination floor information based on the destination floor-related voice information provided by the passenger;
a display unit displaying the destination floor information; and
a controller calling the elevator car in response to the call signal and controlling operation of the voice output unit, the destination floor input module, and the display unit.

2. The elevator input system according to claim 1, wherein:
the contactless input unit comprises at least one of a foot button-based call unit, a detection area recognition-based call unit, or a camera image analysis-based call unit,
the foot button-based call unit comprises a contactless sensor and allows the passenger to input the call signal to the contactless sensor using a part of the body comprising a foot or using an object;
the detection area recognition-based call unit comprises an object detection sensor and allows the call signal to be input based on the presence of the passenger in a detection area in a corresponding elevator hall; and
the camera image analysis-based call unit comprises a camera and an image analyzer,
the camera photographing the elevator hall,
the image analyzer analyzing an image acquired by the camera to determine the presence of the passenger in the elevator hall and allowing the call signal to input based on analysis results.

3. The elevator input system according to claim 2, wherein:
the detection area recognition-based call unit and the camera image analysis-based call unit determine the presence of an additional passenger in real time,
the voice output unit further requests the additional passenger to provide additional destination floor-related voice information;
the voice analyzer of the destination floor input module confirms additional destination floor information; and
the display unit displays the additional destination floor information.

4. The elevator input system according to claim 1, wherein:
the voice output module comprises a speaker and requests the passenger to provide the destination floor-related voice information through the speaker;
the destination floor input module further comprises a microphone and receives the destination floor-related voice information from the passenger through the microphone; and
the display unit displays call information for the elevator car.

5. A method of controlling an elevator input system, comprising:
a contactless call input step in which an elevator car is called through a contactless input unit;
a contactless call recognition step in which a determination is made as to whether there is a call for the elevator car through the contactless input unit;
a destination floor voice information request step in which a voice output unit requests a passenger to provide destination floor-related voice information when the call for the elevator car is confirmed in the contactless call recognition step;
a destination floor voice information recognition step in which destination floor information is confirmed by analyzing the voice information provided by the passenger; and
an elevator car calling and destination floor display step in which the elevator car is called to a corresponding floor based on the confirmed destination floor information and a display unit displays the destination floor information.

6. The method according to claim 5, wherein, when the destination floor information is not confirmed in the destination floor voice information recognition step, the elevator car is called to the corresponding floor and a destination floor is input through destination floor input invocation and voice information input performed by the passenger aboard the elevator car, or the elevator car is called to the corresponding floor in response to input through a call button and the destination floor is input through destination floor input invocation and voice information input performed by the passenger aboard the elevator car.

7. A method of controlling an elevator input system, comprising:
a contactless call input step in which an elevator car is called through a contactless input unit;
a contactless call recognition step in which a determination is made as to whether there is a call for the elevator car through the contactless input unit;
an elevator car calling step in which the elevator car is called to a corresponding floor when the call for the elevator car is confirmed in the contactless call recognition step;
a destination floor voice information request step in which a voice output unit requests a passenger to provide destination floor-related voice information;
a destination floor voice information recognition step in which destination floor information is confirmed by analyzing the voice information; and
a destination floor display step in which a display unit displays the destination floor information.

8. The method according to claim 7, wherein, when the destination floor information is not confirmed in the destination floor voice information recognition step, a destination floor is input through destination floor input invocation and voice information input performed by the passenger aboard the elevator car.

9. The method according to claim 7, further comprising:
an additional destination floor input invocation step in which a voice output unit is invoked to input an additional destination floor;
an additional destination floor voice information request step in which the voice output unit requests additional destination floor-related voice information;
an additional destination floor voice information recognition step in which a voice analyzer recognizes the additional destination floor-related voice information; and
an additional destination floor display step in which additional destination floor information is displayed.

10. The method according to claim 7, further comprising:
an additional passenger confirmation step in which an additional passenger is confirmed through the contactless input unit;
an additional destination floor voice information request step in which the voice output unit requests additional destination floor-related voice information;
an additional destination floor voice information recognition step in which a voice analyzer recognizes the additional destination floor-related voice information; and
an additional destination floor display step in which additional destination floor information is displayed.

11. The method according to claim 7, further comprising:
a destination floor correction invocation step in which a voice output unit is invoked to correct and input a destination floor;
a corrected destination floor voice information request step in which the voice output unit requests the passenger to provide corrected destination floor-related voice information;
a corrected destination floor voice information recognition step in which a voice analyzer recognizes the corrected destination floor-related voice information; and
a corrected destination floor display step in which corrected destination floor information is displayed.

12. The method according to claim 11, wherein, when the corrected destination floor information is not confirmed in the corrected destination floor voice information recognition step, the corrected destination floor voice information request step is performed.
